(19) United States
(12) Patent Application Publication
(10) Pub. No.: US 2022/0152794 A1
(43) Pub. Date: May 19, 2022

(54) Extendable Wrench Tool

(71) Applicant: Abraham Gomez, Indianapolis, IN (US)

(72) Inventor: Abraham Gomez, Indianapolis, IN (US)

(21) Appl. No.: 17/409,769

(22) Filed: Aug. 23, 2021

Related U.S. Application Data
(60) Provisional application No. 63/115,343, filed on Nov. 18, 2020.

(51) Int. Cl. B25B 23/00

(52) U.S. Cl. CPC B25B 23/0021; B25B 23/0042; B25B 23/0014; B25B 23/0035

(57) ABSTRACT

This present invention relates to an extendable wrench and ratchet tool kit comprising a plurality of tool heads, one or more metal shafts or rods, and a metal tube or cylinder including a handle. The extendable wrench and ratchet tool allows an operator to connect any of the metal shafts to the handle at one end and connect any of the tool heads to the shafts at another end. The extendable wrench and ratchet tool kit features a spring-loaded locking mechanism or other similar mechanism to lock the metal shaft or rod at equally spaced grooves in order to selectively extend or retract the metal shaft to a desired length in order to access a fastener positioned in a hard to reach area.

### CROSS-REFERENCE TO RELATED APPLICATION

The present application claims priority to, and the benefit of, U.S. Provisional Application No. 63/115,343, which was filed on Nov. 18, 2020, and is incorporated herein by reference in its entirety.

### FIELD OF THE INVENTION

The present invention relates generally to the field of wrenches and ratchets. More specifically, the present invention relates to an improved wrench tool with an extendable metal shaft, that allows the users to adjust the tool to a desired length. The extendable metal shaft is attached to a handle at one end and is attached to a tool head such as ratchet, spanner, or the like at the other end of the extendable metal shaft. The improved wrench offers a quick-connect for a spanner, adjustable wrench, and other tool heads to help loosen nuts and bolts with ease. Additionally, the improved wrench tool enables the users to access nuts and bolts from a desired position and angle to gain ample leverage when tightening or loosening the fastener. The wrench tool of the present invention extends to provide a longer reach and increased torque, with respect to conventional wrench tools. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, various kinds of hand tools are used by individuals to loosen or tighten bolts, screws, or similar items. Conventional hand tools such as screwdrivers, ratchet wrenches, and lug wrenches are all torque-based tools that require twisting and turning of the tool handle to loosen or tighten bolts, nuts, screws, or the like. Individuals using such tools usually face problems of insufficient length to reach the desired nut in order to loosen or tighten it. If unable to reach the nuts, bolts, screws or the like, individuals will be prohibited from loosening or tightening the nuts and bolts with standard wrenches. Additionally, some nuts and bolts are at awkward angles that make it inconvenient to access the nuts and bolts, and therefore prohibit an individual from being able to remove or install the desired fastener using standard tools. Different kinds of tools are required for different jobs, and a single hand tool may not be able to serve a variety of situations. As an example, an open-end wrench, a box-end wrench, an adjustable wrench, a spanner and other tools are typically used by individuals for specific purposes. A user needs to separately buy each of the tools to accommodate all their needs and requirements.

Standard wrenches and other hand tools can be frustrating to use. Individuals may suffer injury trying to apply too much force in order to gain leverage on a nut or bolt. Even with considerable strength and dexterity, some nuts and bolts may not be able to be loosened/tightened with a standard wrench.

Various solutions are available in the state of the art to allow users to loosen or tighten screws, nuts, bolts and more at unreachable locations. For example, some extra-long tools are manufactured to make hard-to-reach areas reachable. However, such tools are neither portable nor easy to store. An efficient, extendable, and portable tool is therefore desired by the users.

Therefore, there exists a long felt need in the art for a wrench tool that allows the users to easily reach screws, nuts, bolts, and other similar items placed in hard-to-reach areas. There is also a long felt need in the art for a wrench tool that extends the length of standard tool heads and enables the users to easily loosen or tighten the screws, nuts, bolts and more. Additionally, there is a long felt need in the art for a wrench tool kit that eliminates the need to buy different types of hand tools separately and accommodates different needs of the users. Moreover, there is a long-felt need in the art for a wrench tool that is convenient to use by the users. Further, there is a long-felt need in the art for a modified wrench that is portable and easily stored by the users. Finally, there is a long-felt need in the art for an efficient and cost-effective wrench tool that can easily loosen or tighten screws, bolts, etc. with limited physical force or effort.

The subject matter disclosed and claimed herein, in one embodiment thereof, comprises an extendable wrench and ratchet device with interchangeable tool heads. The extendable wrench device comprises: a cylindrical hollow metal shaft having a plurality of equidistant grooves along the length, and an integrated connector at a first end; a hollow metal tube having a spring-loaded locking mechanism wherein the locking mechanism is operable by a spring-loaded collar; the hollow metal shaft is operable to extend from the hollow metal tube and can be locked within the metal tube upon engaging the spring-loaded collar to one of the equidistant grooves; and, the integrated connector receives interchangeable tool heads, such as, ratchets, wrenches, spanners or other tool heads, that can be secured using a retention screw.

In this manner, the novel extendable wrench of the present invention accomplishes all of the forgoing objectives, and provides a relatively safe, easy, convenient, and effective solution to loosen or tighten nuts, bolts, screws, etc. which are placed in hard-to-reach areas. The extendable wrench of the present invention is also user-friendly, inasmuch as it is less expensive than other alternatives, and does not require the user to exert a great deal of force or effort into loosening or tightening nuts, screws or more, placed at difficult locations and angles. Additionally, the extendable wrench tool is detachable, and therefore is portable and easily stored.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an extendable wrench and ratchet device with interchangeable tool heads. The extendable wrench device comprises: a cylindrical hollow metal shaft having a plurality of equidistant grooves along the length, and an integrated connector at a first end; a hollow metal tube having a spring-loaded locking mechanism wherein the locking mechanism is operable by a spring-loaded collar; the hollow metal shaft is operable to extend from the hollow metal tube, and can be locked within the metal tube upon engaging the spring-loaded collar to one of the equidistant grooves; and, the integrated connector receives interchangeable tool heads, such as, ratchets, wrenches, spanners or other tool heads, that can be secured using a retention screw.

In a further embodiment of the present invention, an extendable wrench tool with a connector head is disclosed and comprises: an elongated body having an extendable metal shaft and a hollow metal tube; a tool head set having a plurality of tool heads; the extendable metal shaft having four vertical grooves on the top side and a connecting head configured to engage a tool head from the tool head set; the extendable metal shaft is operable to extend from the hollow metal tube and lock at a designated length within the metal tube, using a locking mechanism to engage with one of the four vertical grooves; and, the locking mechanism is operable by a spring-loaded collar or a rocker button on a grip covering a portion of the metal tube. The locking mechanism can be any one or more of the following: a locking pin connected to the spring mechanism, a smaller elongated slot in the metal tube, twisted locks, any conventional type of collar lock, a spring-loaded sliding mechanism, or any type of collar, detent and ball, or spring mechanism.

The metal shaft can have an integrated or replaceable connector to engage a tool head for performing bolt, nut or screw tightening or loosening action, or any other similar mechanical action. The metal shaft has four equidistant vertical grooves which are shaped and dimensioned to engage with the spring-loaded mechanism having a connected detent ball or with any other locking mechanism present within the hollow metal tube.

The advantage of the present invention is that it provides users with an improved wrench with a selectively extendable metal shaft, thereby allowing users to adjust the length of the shaft to a desired length. The present invention includes ratchets, wrenches, spanners and other tool heads capable of being attached to the extendable shaft. The present invention enables users to access nuts and bolts from a desired position and angle to gain ample leverage when tightening or loosening fasteners. The main metal shaft or rod slides into the metal cylinder tube with an ergonomic handle at the end.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the extendable wrench tool kit of the present invention in accordance with the disclosed architecture;

FIG. 2 illustrates a perspective view of one potential embodiment of the extendable metal shaft of the extendable wrench tool of the present invention being locked within the metal tube at a desired length in accordance with the disclosed architecture;

FIG. 3 illustrates a perspective view of the various tool heads that may be connected to one potential embodiment of the extendable wrench tool of the present invention in accordance with the disclosed architecture;

FIG. 4 illustrates a perspective view of one potential embodiment of a tool head (from a plurality of potential tool heads) connected to the extendable wrench tool of the present invention in accordance with the disclosed architecture;

FIG. 5 illustrates a perspective view of another potential embodiment of a tool head (from a plurality of potential tool heads) connected to the extendable wrench tool of the present invention in accordance with the disclosed architecture; and

FIG. 6 illustrates a perspective view of two different embodiments of the extendable wrench tool of the present invention with connected tool heads being used in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long felt need in the art for a wrench tool that allows the users to easily reach screws, nuts, bolts and other similar items placed in hard-to-reach areas. There is also a long felt need in the art for a wrench tool that extends the length of standard tool heads and enables the users to easily loosen or tighten the screws, nuts, bolts and more. Additionally, there is a long felt need in the art for a wrench tool kit that eliminates the need to buy different types of hand tools separately and accommodates different needs of the users. Moreover, there is a long felt need in the art for a wrench tool that is convenient to use. Further, there is a long felt need in the art for a modified wrench that is portable and easily stored by the users. Finally, there is a long felt need in the art for an efficient and cost-effective wrench tool that can easily loosen or tighten screws, bolts, etc. with limited physical force or effort.

The present invention, in one exemplary embodiment, is a novel extendable wrench and ratchet device with interchangeable tool heads. The extendable wrench device comprises: a cylindrical hollow metal shaft or rod having a plurality of equidistant grooves along the length and an integrated connector at a first end; a hollow metal tube or cylinder having a spring-loaded locking mechanism wherein the locking mechanism is operable by a spring-loaded collar; the hollow metal shaft is operable to extend from the hollow metal tube and can be locked within the metal tube upon engaging the spring-loaded locking mechanism or collar to one of the equidistant grooves; and, the integrated connector receives interchangeable tool heads, such as, ratchets, wrenches, spanners, or other tool heads, that can be secured using a retention screw.

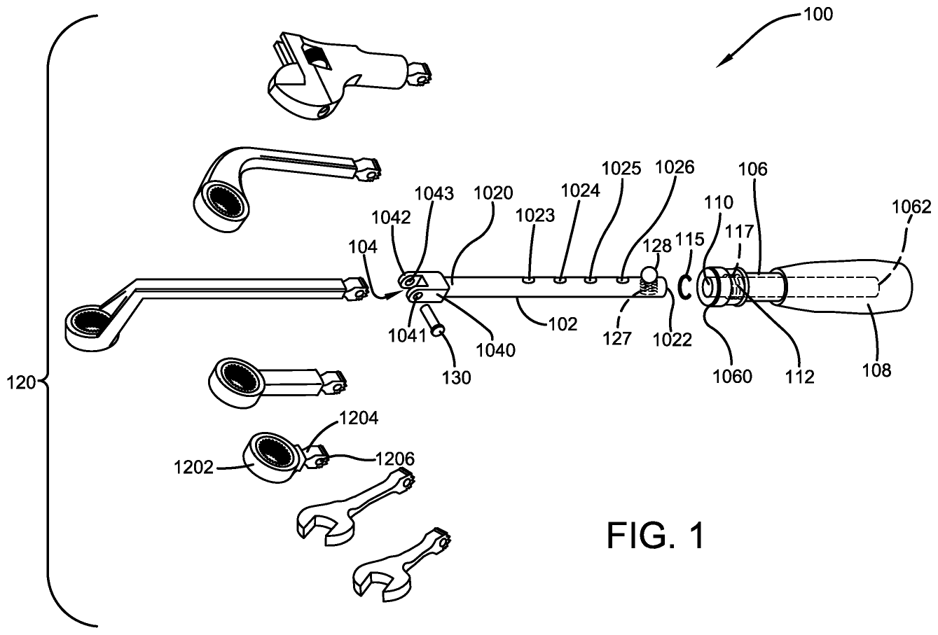

Referring initially to the drawings, FIG. 1 illustrates a perspective view of one potential embodiment of the extendable wrench tool kit of the present invention in accordance with the disclosed architecture. More specifically, the extendable wrench and ratchet tool kit 100 of the present invention has a cylindrical metal shaft 102 having a first end 1020 and a second end 1022. At the first end 1020, a connector 104 is permanently attached and the connector 104 is designed to receive ratchets, wrenches, spanners or other tool heads. Various tool heads 120 are also included in the extendable wrench and ratchet tool kit 100 and are designed to be easily engaged with the connector 104. In the present embodiment, the connector 104 has two arms 1040, 1042 each having a hole 1041, 1043, respectively. A pin or fastener is used to engage and fasten one of the tool heads 120 to the connector 104.

The cylindrical metal shaft or rod 102 has recessed grooves 1023, 1024, 1025, 1026 which are used for locking the cylindrical metal shaft 102 within a metal tube or cylinder 106. The circular and hollow metal tube 106 has an open first end 1060 and a closed second end 1062. The open end 1060 has an opening 110 to receive the second end 1022 of the metal shaft 102 through which the metal shaft 102 is inserted within the metal tube 106. At the far end 1062, the metal tube 106 is connected to an ergonomic handle 108 which can be held by an operator or technician while using the extendable wrench and ratchet tool kit 100.

The metal tube 106 has a spring-releasing mechanism with a detent ball 118 for locking the metal shaft 102 while extending or retracting. A collar spring 117 actuates a detent ball 118 when a collar 112 is moved fore and aft along tube 106. The detent ball 118 in the present embodiment is actuated by spring 117 and is an appropriate size to fit snugly within the grooves 1023, 1024, 1025, 1026 of the metal shaft 102. The collar 112 and collar spring 117 can be retained by a first split ring 115 at one end, and a second split ring 125 at another end. The collar 112 and collar spring 117 can disengage the detent ball 118 from an engaged groove by using the spring 117 to actuate detent ball 118 for extending or retracting the cylindrical metal shaft 102. Actuating collar 112 moves the collar spring 117 and detent ball 118 from a retained position to a released position. A second spring biased 127 detent ball 128 can be used to retain and support shaft 102 within cylinder or tube 106.

The grooves 1023, 1024, 1025, 1026 are equidistant and present on one side of the metal shaft 102 and are configured to be engaged with the detent ball 118 for a secure fit. Selectively extending, or retracting, the shaft 102 customizes the length of the metal shaft 102 in order to reach, loosen, or tighten nuts and bolts with ease. The grooves 1023, 1024, 1025, 1026 can be spaced at ½, 1, or 2 inch increments to lock the metal shaft or rod 102 within the metal tube or cylinder 106. The plurality of grooves 1023, 1024, 1025, 1026 are recessed about an outer perimeter of the rod 102 and partially circumscribe same. A retention of a first groove 1023 defines a first extension length, a retention of a second groove 1024 defines a second extension length, a retention of a third groove 1025 defines a third extension length, and a retention of a fourth groove 1026 defines a fourth extension length; respectively, of the shaft or rod 102 relative to the cylinder 106. In one exemplary arrangement, the second extension length is at least 50% greater than the first extension length. In another exemplary arrangement, the second extension length is at least 60% greater than the first extension length. In one exemplary arrangement, the third extension length is at least 100% greater than the first extension length. In another exemplary arrangement, the third extension length is at least 120% greater than the first extension length. In one exemplary arrangement, the fourth extension length is at least 150% greater than the first extension length. In another exemplary arrangement, the fourth extension length is at least 160% greater than the first extension length.

The collar 112 and collar spring 117 operate to engage and release the detent ball 118 from the grooves 1023, 1024, 1025, 1026. The engaging and releasing allows the metal shaft 102 to extend and retract. The metal tube 106 also can include a second detent ball 128 biased by a spring 127 to additionally secure and fasten the metal shaft 102 within the metal tube 106.

For performing any fastening operation, one of the tool heads 120 available with the kit 100 is chosen and is engaged and securely fit to the connector 104. Based on the requirement of a technician or operator, any compatible tool head is used with the metal shaft 102 and the metal tube 106.

To use a tool head 1202 with the extendable wrench, the tool head 1202 is fastened to the connector 104 using a retention screw or a guiding pin 130 which fastens the tool head 120 securely to the connector 104. A mounting base or arm 1204 of the tool head 1202 is placed between the arms 1040, 1042 of the connector 104. A tool head base hole 1206 is aligned with the holes 1041, 1043 of the connector 104 and the retention screw or a guiding pin 130 is inserted through the holes 1041, 1043, 1206 and fastened for securing the tool head 1202 with the connector 104. The retention screw or a guiding pin 130 functions as a detent to any of the tool heads 120. The tool heads 120 are retained during their usage to prevent them from slipping off the connector 104.

The length of the metal shaft 102 is adjusted using the grooves 1023, 1024, 1025, 1026 and the ball spring mechanism 117, 118 wherein an appropriate tool head 120 can be connected to the connector 104 for an effective and easy operation of removing, tightening, or fastening a bolt or screw. The extendable wrench kit 100 gives the ability to reach bolts and screws in tight and hard-to-reach areas. For example, a mechanic using the kit 100 can now reach bolts and screws that might otherwise require the removal of unnecessary parts to reach. The extendable wrench and ratchet 100 can be utilized for lots of other tasks too, including jobs involving working various types of machines, plumbing and carpentry.

The adjustable and extendable wrench 100 can be available in sets with different-sized and shaped connectors 104. For example, the connector 104 can be available in ¼, ⅜, ½, ¾ and 1 inch sizes. Complete sets of tool heads and connectors enable the mechanic or technician to use a variety of tool heads while working. The mechanic can simply select a tool head 120 with the coordinating connector 104, extend or retract the extendable metal shaft 102 within the metal tube 106 and secure same to the necessary length to complete the job.

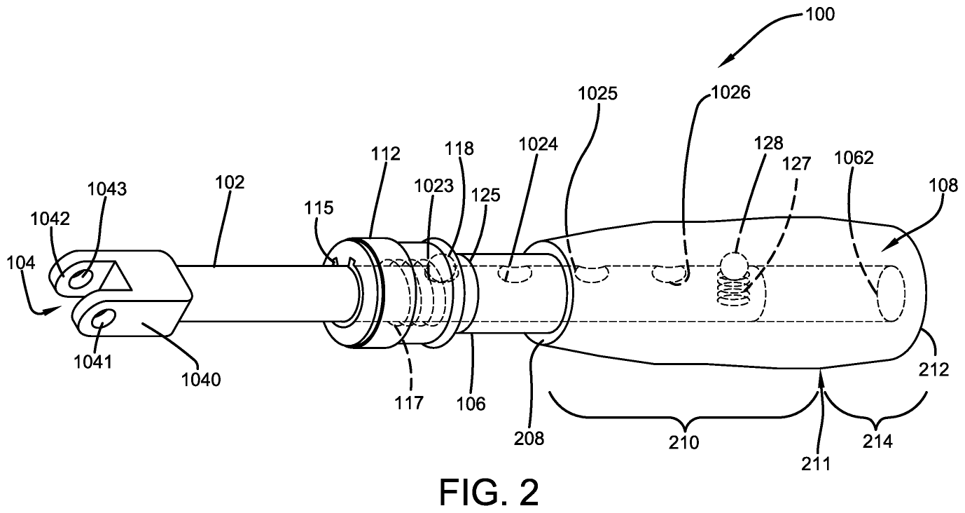

FIG. 2 illustrates a perspective view of one potential embodiment of the extendable metal shaft of the extendable wrench tool of the present invention being locked within the metal tube at a desired length in accordance with the disclosed architecture. More specifically, the detent ball 118 is engaged with one of the grooves, for example groove 1025, of the extendable metal shaft 102 to lock the shaft 102 in the desired length. When the collar 112 is pulled, the collar spring 117 actuates detent ball 118 to disengage from the groove 1025 and the metal shaft 102 can be extended or retracted by engaging the ball 118 with any other groove of the metal shaft 102. The collar 112 and collar spring 117 pulls or pushes the ball 118 for locking the metal shaft 102 in a selected groove.

It should be appreciated that other means for locking the metal shaft 102 in the metal tube 106 using the grooves 1023, 1024, 1025, 1026 can be used. In alternative embodiments of the present invention, locking mechanisms such as a locking pin connected to the spring mechanism, a smaller elongated slot in the metal tube, twisted locks, any conventional type of push button lock, spring-loaded sliding mechanism, threaded collar, ball or spring mechanism can be used. As best illustrated in FIG. 2, the extendable wrench 100 includes an ergonomic handle 108. The handle 108 comprises a neck end 208 and a distal or terminal end 212. The handle 108 includes a first tapered section 210 from a middle portion 211 to the neck end 208. The handle further comprises a second tapered section 214 from the middle portion 211 to the distal end 212. The first tapered section 210 includes a first progressive decrease in diameter from the middle portion 211 to the neck end 208. The second tapered section 214 includes a second progressive decrease in diameter from the middle portion 211 to the distal end 212. The first progressive decrease in diameter exceeds the second decrease in diameter.

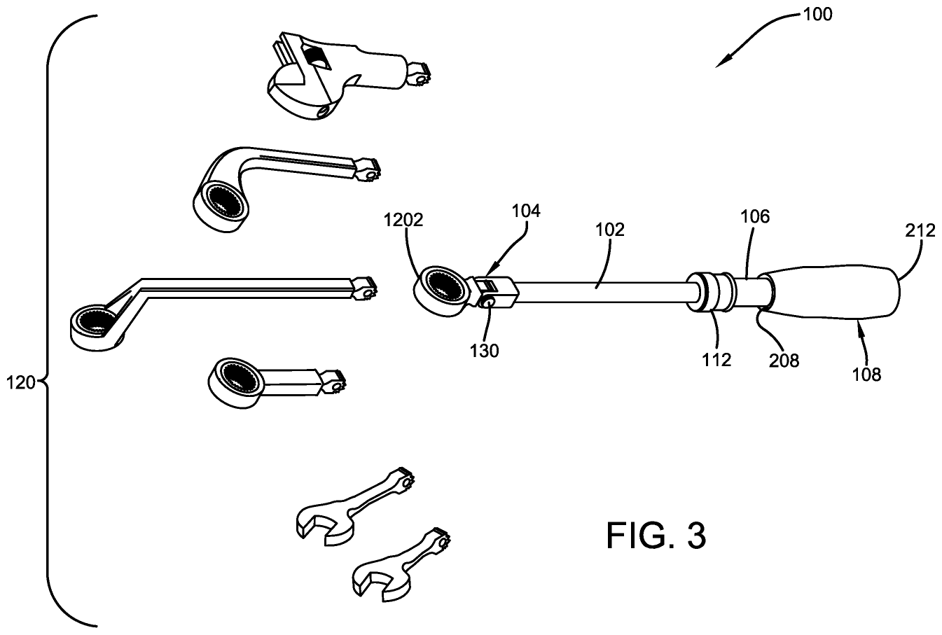

FIG. 3 illustrates a perspective view of the various tool heads that may be connected to one potential embodiment of the extendable wrench tool of the present invention in accordance with the disclosed architecture. More specifically, for performing a specific task of tightening or loosening a screw or nut, a desired tool head 1202 is selected from the tool head set 120 which comes in the extendable wrench kit 100 of the present invention. A mechanic or user, after locking the metal shaft 102 to a desired length, connects the desired tool head 1202 to the connector 104 using the screw or a guiding pin 130. As stated earlier, the screw or a guiding pin 130 passes through the aligned holes 1041, 1043 of the connector 104 and the tool head base hole 1206 for a secure fit.

For lengthening or shortening the length of the metal shaft 102, the collar 112 and collar spring 117 can be actuated by a mechanic or an operator. This activates the lock engaging and disengaging mechanism to release or lock the metal shaft 102. The grooves present on a side of the metal shaft 102 are then selectively engaged to the locking mechanism to adjust the length or extension of the shaft 102.

The tool head 1202 connected to the extendable wrench is used for performing the mechanical torquing operations in a secure and stable manner. The adjustable shaft 102 allows the mechanic to have a selectable length shaft for fastening or loosening bolts more readily in hard-to-reach areas. The lengthening shaft 102 enables a greater torque than a shorter shaft with the same applied force.

Any tool head of the tool head set 120 can be used such as a spanner, a ratchet, and the like, which can be added to the connector 104. It is to be appreciated that the mechanic does not need to carry different types of wrenches, as the single device is adjustable and can be used with all types of tool heads.

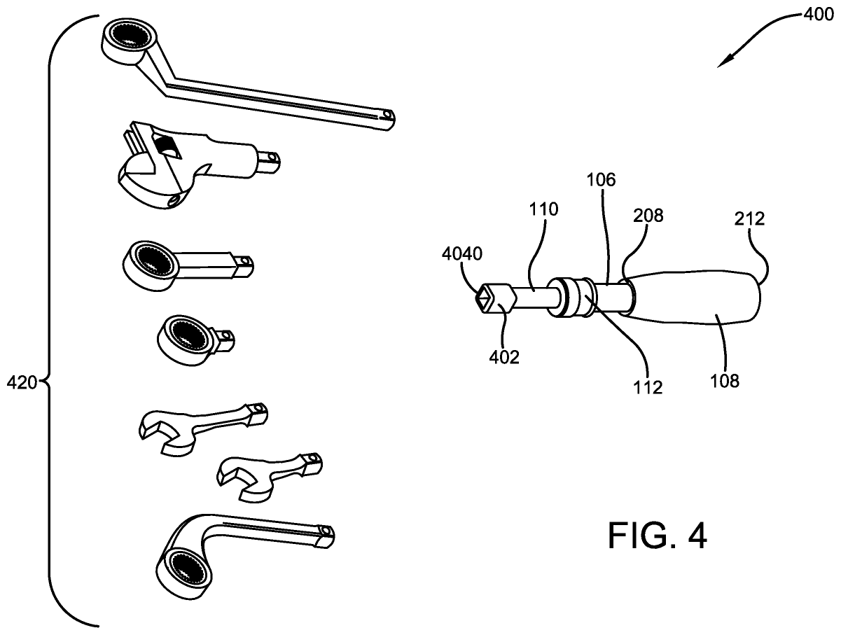

FIG. 4 illustrates a perspective view of one potential embodiment of a tool head (from a plurality of potential tool heads) connected to the extendable wrench tool of the present invention in accordance with the disclosed architecture. More specifically, the extendable wrench and ratchet tool kit 400 in the present embodiment has a second type of connector 404 with a rectilinear opening 4040 to receive a tool head from a tool head set 420. The second connector 404 can have a closed-loop for rectilinear, hexagonal or square nuts. The tools of the tool head set 420 have a compatible rectilinear base to engage in the second connector 404. The tool head set 420 has different tool heads such as ratchets, wrenches, spanners and other tool heads. The metal shaft 402 is extendable and can include four grooves on the top side, similar to the metal shaft 102 described above, for selective extension, retraction, and retention. The metal shaft 402 can be extended or retracted using a locking mechanism within the metal tube or cylinder 106.

It is to be appreciated that in a commercially-available kit of the present invention, the tool head set 120, 420 and metal shafts 102, 402 are available to assist a mechanic or operator to perform all types of tightening or loosening operations. The tool heads 420 are interchangeable and can be used with the appropriate metal shaft connector. The connector 404 can be integrated to the metal shaft or can be replaceable. The tool heads in the tool head set 120, 420 can be used in any of a variety of situations, for example, fastening or dismantling pipes and their units, tightening or loosening nuts or bolts, tightening wheel lug nuts and any other mechanical or assembly type work.

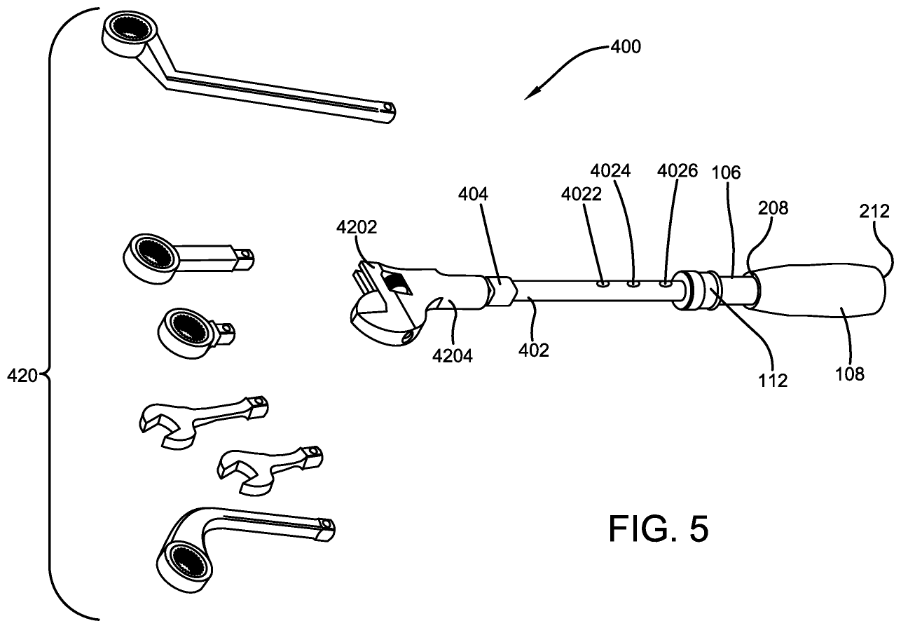

FIG. 5 illustrates a perspective view of another potential embodiment of a tool head (from a plurality of potential tool heads) connected to the extendable wrench tool of the present invention in accordance with the disclosed architecture. In the present embodiment, a spanner or crescent wrench 4202 is connected to the connector 404 with the base 4204 screwed in the closed-loop opening of the connector 404. The metal shaft 402 is extended to the desired length with the locking mechanism of the wrench locked in one of at least three grooves present on the metal shaft 402. The grooves 4022, 4024, 4026 are accessible and the length can be adjusted as described above. The wrench 4202 can be a crescent wrench in the present embodiment.

It should be appreciated that any conventional means for locking the metal shaft 402 in the metal tube 106 using the at least three grooves 4022, 4024, 4026 and a fourth groove (not shown). In the embodiments of the present invention, locking mechanisms such as a locking pin connected to the spring mechanism, a smaller elongated slot in the metal tube, twisted locks, any conventional type of push button lock, spring-loaded sliding mechanisms, threaded collars, ball or spring mechanisms can be used.

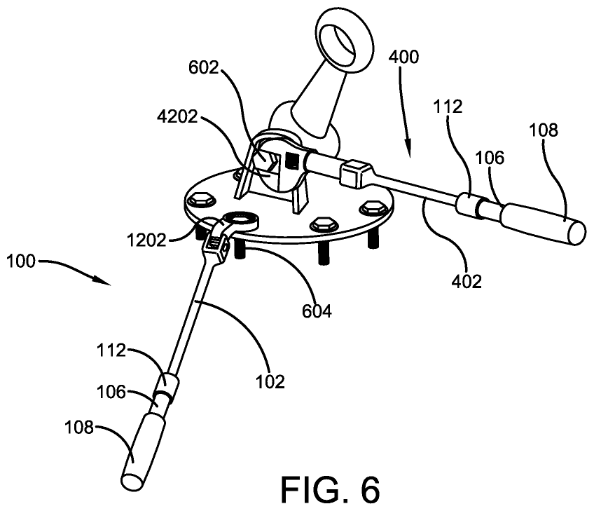

FIG. 6 illustrates a perspective view of two different embodiments of the extendable wrench tool of the present invention with connected tool heads being used in accordance with the disclosed architecture. As shown, to perform a screw tightening and loosening operation involving different types of nuts, bolts, screws and other fasteners, a first extendable wrench 100 having a metal shaft 102 connected to metal tube 106, and having a tool head 1202, is used for operating on a bolt 604.

Similarly, a second extendable wrench 400 having a metal shaft 402 connected to metal tube 106, and having a spanner tool head 4202, is used for operating on a bolt 602. A mechanic or an operator can work easily with two wrenches, each with a single hand. Also, operations in hard-to-reach areas can be performed using the extendable wrenches and interchangeable tool heads as described.

The present invention allows a mechanic or an operator to change the tool head easily to handle a variety of tasks. Each tool head, metal shaft/rod and metal tube/cylinder is built for exceptional comfort, durability, and utility. By actuating collar and collar spring, the metal shaft can be extended to the proper position for attaching to a bolt or screw. Once the proper length is determined, releasing the collar allows the metal shaft to be locked into position.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “extendable wrench and ratchet tool kit”, “extendable wrench kit”, “extendable wrenches”, and “adjustable and extendable wrench” are interchangeable and refer to the extendable wrench and ratchet tool kit 100, 400 of the present invention.

Notwithstanding the forgoing, the extendable wrench and ratchet tool kit 100, 400 of the present invention can be of any suitable size and configuration as is known in the art without affecting the overall concept of the invention, provided that it accomplishes the above-stated objectives. One of ordinary skill in the art will appreciate that the size, configuration and material of the extendable wrench and ratchet tool kit 100, 400 as shown in the FIGS. are for illustrative purposes only, and that many other sizes and shapes of the extendable wrench and ratchet tool kit 100 are well within the scope of the present disclosure. Although the dimensions of the extendable wrench and ratchet tool kit 100, 400 are important design parameters for user convenience, the extendable wrench and ratchet tool kit 100, 400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An extendable wrench tool comprising:
a rod having a first end and a second end;
said first end comprising a connector for attaching a variety of tools;
said connector includes a first arm and a second arm;
said first arm includes a first hole therethrough and said second arm includes a second hole therethrough;
each of said variety of tools comprise a mounting base with a mounting hole therethrough;
a retention pin passing through said first hole, said mounting hole, and said second hole for selectively securing said each of the variety of tools;
said rod comprising a plurality of recessed grooves partially circumscribing an outer perimeter of said rod;
a cylinder for selectively receiving a length of said rod;
a retention mechanism including a spring releasing mechanism with a detent ball for locking one of said plurality of grooves and said rod relative to said cylinder;
said plurality of grooves spaced apart along said rod; and
a selected extension of said rod from said cylinder determinable by said selective locking of said detent ball in a selected one of said plurality of grooves.

2. The extendable wrench tool of claim 1, wherein said plurality of grooves are equidistant to each other and include at least three grooves.

3. The extendable wrench tool of claim 2 further comprising a collar and collar spring for actuating said spring releasing mechanism and said detent ball from a retained position to a released position.

4. The extendable wrench tool of claim 3, further comprising another spring actuated detent ball for retaining said rod within said cylinder.

5. The extendable wrench tool of claim 1, wherein said plurality of grooves are equidistant to each other and include at least four grooves.

6. The extendable wrench tool of claim 5 further comprising a retention of a first groove defining a first extension length, a retention of a second groove defining a second extension length, a retention of a third groove defining a third extension length, a retention of a fourth groove defining a fourth extension length; respectively, of said rod relative to said cylinder.

7. The extendable wrench tool of claim 6, wherein said second extension length is at least 50% greater than said first extension length.

8. The extendable wrench tool of claim 7, wherein said second extension length is at least 60% greater than said first extension length.

9. The extendable wrench tool of claim 6, wherein said third extension length is at least 100% greater than said first extension length.

10. The extendable wrench tool of claim 9, wherein said third extension length is at least 120% greater than said first extension length.

11. The extendable wrench tool of claim 6, wherein said fourth extension length is at least 150% greater than said first extension length.

12. The extendable wrench tool of claim 11, wherein said fourth extension length is at least 160% greater than said first extension length.

13. An extendable wrench tool comprising:
a rod having a first end and a second end;
said first end comprising a connector for attaching a variety of tools;
said rod comprising a plurality of recessed grooves partially circumscribing an outer perimeter of said rod, wherein said plurality of recessed grooves are spaced equidistant to each other and include at least four grooves along said rod;
a cylinder for selectively receiving a length of said rod;
a retention mechanism including a spring releasing mechanism with a detent ball for locking one of said plurality of recessed grooves and said rod relative to said cylinder;
a selected extension of said rod from said cylinder determinable by said selective locking of said detent ball in a selected one of said plurality of recessed grooves; and
a retention of a first groove defines a first extension length, a retention of a second groove defines a second extension length, a retention of a third groove defines a third extension length, a retention of a fourth groove defines a fourth extension length; respectively, of said rod relative to said cylinder.

14. The extendable wrench tool of claim 13, wherein said connector includes a first arm having a first hole therethrough and a second arm having a second hole therethrough, and further wherein each of said variety of tools comprise a mounting base with a mounting hole therethrough and a retention pin passing through said first hole, said mounting hole, and said second hole for securing said each of a variety of tools.

15. The extendable wrench tool of claim 13 further comprising a collar and collar spring for actuating said spring releasing mechanism and said detent ball from a retained position to a released position.

16. The extendable wrench tool of claim 15, wherein said second extension length is at least 50% greater than said first extension length.

17. The extendable wrench tool of claim 16, wherein said third extension length is at least 100% greater than said first extension length.

18. The extendable wrench tool of claim 17, wherein said fourth extension length is at least 150% greater than said first extension length.

19. The extendable wrench tool of claim 18, wherein said fourth extension length is at least 160% greater than said first extension length.

20. An extendable wrench tool comprising:
a rod having a first end and a second end;
said first end comprising a connector for attaching a variety of tools;
said rod comprising a plurality of recessed grooves partially circumscribing an outer perimeter of said rod, wherein said plurality of recessed grooves are spaced equidistant to each other and include at least four grooves along said rod;
a cylinder for selectively receiving a length of said rod;
a retention mechanism including a spring releasing mechanism with a detent ball for locking one of said plurality of recessed grooves and said rod relative to said cylinder;
a selected extension of said rod from said cylinder determinable by said selective locking of said detent ball in a selected one of said plurality of recessed grooves;
a retention of a first groove defines a first extension length, a retention of a second groove defines a second extension length, a retention of a third groove defines a third extension length, a retention of a fourth groove defines a fourth extension length; respectively, of said rod relative to said cylinder.
a handle including a neck end and a terminal end;
said handle includes a first tapered section extending from a middle portion of said handle to said neck end, and a second tapered section extending from said middle portion to said terminal end;
said first tapered section includes a first progressive decrease in diameter from said middle portion to said neck end, and said second tapered section includes a second progressive decrease in diameter from said middle portion to said distal end; and
said first progressive decrease in diameter exceeds said second decrease in diameter.
